(19) United States
(12) Patent Application Publication
(10) Pub. No.: US 2013/0218793 A1
(43) Pub. Date: Aug. 22, 2013

(54) Architecture, System, and Method for Immigration Compliance Auditing

(71) Applicants: Charles M. Miller, Studio City, CA (US); S. Christopher Stowe, JR., Warwick, RI (US); Marcine A. Seid, Palo Alto, CA (US)

(72) Inventors: Charles M. Miller, Studio City, CA (US); S. Christopher Stowe, JR., Warwick, RI (US); Marcine A. Seid, Palo Alto, CA (US)

(21) Appl. No.: 13/769,289

(22) Filed: Feb. 16, 2013

Related U.S. Application Data
(60) Provisional application No. 61/601,094, filed on Feb. 21, 2012.

(51) Int. Cl. G06Q 10/10

(52) U.S. Cl. CPC G06Q 10/105
USPC 705/320

(57) ABSTRACT

A computer based system for immigration compliance auditing includes executable program instruction sets configured for: processing and analyzing immigration compliance verification documentation for a set of employees associated with an employer, where such documentation includes Form I-9s and related information; identifying statutory and technical/procedural Form I-9 compliance violations; mapping identified Form I-9 statutory compliance violations and technical/procedural compliance violations to categorical types of statutory compliance violations and technical/procedural compliance violations, respectively; automatically generating an immigration compliance violation liability estimate for the employer in a manner correlated with occurrences of categorical types of statutory compliance violations and occurrences technical/procedural compliance violations; generating an immigration compliance audit report; and possibly managing immigration compliance violation remediation procedures.

### CROSS REFERENCE TO RELATED APPLICATIONS

This application claims priority to U.S. Provisional Patent Application Ser. No. 61/601,094, entitled “Architecture, System, and Method for Immigration Compliance Auditing,” filed on 21 Feb. 2012, which is incorporated herein by reference in its entirety.

### TECHNICAL FIELD

The present disclosure relates generally to systems and methods for managing and analyzing worker information or documentation in view of statutory, regulatory, and other agency compliance requirements. More particularly, aspects of the present disclosure are directed to computer based systems and methods for processing and analyzing immigration compliance verification documentation, such as Form I-9s and related information, and automatically generating immigration compliance audit reports which include violation liability estimates corresponding to such worker information.

### BACKGROUND

The Department of Homeland Security (DHS) and its predecessor agency, the Immigration and Naturalization Service (INS), were charged with responsibility for the administrative enforcement of the Immigration Reform and Control Act (IRCA) employer's sanctions laws. IRCA makes it unlawful for an employer, recruiter, or referrer for a fee to knowingly hire for U.S. employment an unauthorized alien. IRCA also makes it the responsibility of every United States employer to conduct employment verification. Under this verification system, all employers are required to examine the documentation of identity and the legal right to work of every new employee, whether U.S. citizen, national or alien, hired after Nov. 6, 1986. Both the employer and employee must make attestations on Form I-9, a current standard version of which is shown in FIG. 1A.

Current law provides for civil fines for violations of the record-keeping requirements of up to $1,100 per employee. Employers who knowingly hire or continue to hire unauthorized aliens are subject to a graduated scale of civil fines of up to $16,000 per unauthorized alien for a third offense. Repeat offenders who engage in a pattern or practice of hiring unauthorized aliens face criminal fines and imprisonment for up to six months. These employer sanctions laws are found in amendments to the Immigration and Nationality Act (INA) and corresponding U.S. Code sections. As construed herein, regulatory requirements can include official (e.g., federal, state, and/or local) statutes, regulations, and/or associated implementing rules.

Immigration attorneys having specific expertise can undertake particular type of employer audits to determine or estimate an employer's Form I-9 compliance violations, and the employer's potential financial liability associated with such violations. More specifically, Form I-9 external audits are undertaken to determine whether an employer's I-9 verification compliance program, policies, and training meet statutory and regulatory requirements. The auditor seeks to identify Form I-9 compliance violations, and make determinations as to statute of limitation considerations associated with statutory and regulatory Form I-9 compliance violations. The auditor may provide recommendations as to mitigation methods for identified Form I-9 compliance violations. Immigration compliance liability auditing is undertaken to assess civil and criminal penalty liability, violations of agency regulations, as well as liability under anti-discrimination and unfair immigration-related employment and practices. Such liability audits determine whether the results of an external Form I-9 audit give rise to potential liability for employer sanctions civil penalties, knowingly hired penalties, paperwork violations, and indemnification violation penalties. Based upon a liability audit, the immigration attorney can guide the employer with respect to immigration compliance remediation as well as mitigation methods for potential penalties.

Unfortunately, Form I-9 external audits and immigration compliance liability audits are typically complex, time consuming, and expensive procedures that require specialized expertise, including detailed knowledge of current statutes and regulations and the manner in which the statutes and regulations may or may not be applicable depending upon situational details. Additionally, such audits can involve the analysis of very large amounts of information, particularly with respect to large employers. Furthermore, standardized, publicly available procedures for arriving at immigration compliance liability estimates do not exist. Hence, when such audits are performed by different individuals, differing potential immigration compliance liability estimates can arise due to different manners of interpreting situational or regulatory details, and a given potential immigration compliance liability estimate can be significantly inaccurate with respect to an employer's actual immigration compliance liability.

A need exists for aiding employers as well as immigration attorneys in efficiently, consistently, and cost effectively managing employer immigration compliance, performing Form I-9 audits, performing immigration compliance liability audits, managing the results of such audits, and determining and managing potential employer immigration compliance liabilities.

### BRIEF DESCRIPTION OF THE DRAWINGS

FIG. 1A depicts a standard Form I-9.

FIG. 1B is a schematic illustration of a tablet computer presenting an electronic Form I-9 and providing a Form I-9 information entry interface in accordance with an embodiment of the present disclosure.

FIG. 2 is a schematic illustration of an architecture for immigration compliance auditing, which includes an immigration compliance auditing system, in accordance with an embodiment of the present disclosure.

FIG. 3 is a block diagram of particular software modules corresponding to a compliance auditing system in accordance with an embodiment of the present disclosure.

FIG. 4 is a schematic illustration of a representative Form I-9 immigration compliance audit graphical user interface (GUI) in accordance with an embodiment of the present disclosure.

FIG. 5A is a representative a Form I-9 compliance audit violation mapping in accordance with an embodiment of the present disclosure.

FIG. 5B is a schematic illustration of a Form I-9 audit checklist/memorandum, which can be presented by a display device of a tablet computer or other computing device.

FIGS. 5C-5E depict Form I-9 compliance violation penalty fine schedules.

FIG. 5F depicts Form I-9 compliance violation penalty adjustment factors.

FIG. 6A illustrates a representative Form I-9 immigration compliance audit database interface in accordance with an embodiment of the present disclosure.

FIG. 6B illustrates further aspects of the Form I-9 immigration compliance audit database interface of FIG. 6A.

FIG. 7A illustrates a representative Form I-9 Individual Employee Audit Report in accordance with an embodiment of the present disclosure.

FIG. 7B illustrates a representative Form I-9 Aggregate Immigration Compliance Violation Report in accordance with an embodiment of the present disclosure.

FIG. 8A illustrates a representative Form I-9 Immigration Compliance Audit Liability Report in accordance with an embodiment of the present disclosure.

FIGS. 8B-8D illustrate particular representative Form I-9 Audit Liability Statistical Reports in accordance with an embodiment of the present disclosure.

FIG. 9A is a flow diagram of a representative process for performing Form I-9 compliance auditing operations in accordance with an embodiment of the present disclosure.

FIG. 9B is a flow diagram of a representative process for managing Form I-9 compliance auditing information, results, and/or remediation activities in accordance with an embodiment of the present disclosure.

### DETAILED DESCRIPTION

In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated.

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a system, an apparatus, a device, a structure, an object, a process, a physical parameter, or a value depending upon the type of set under consideration.

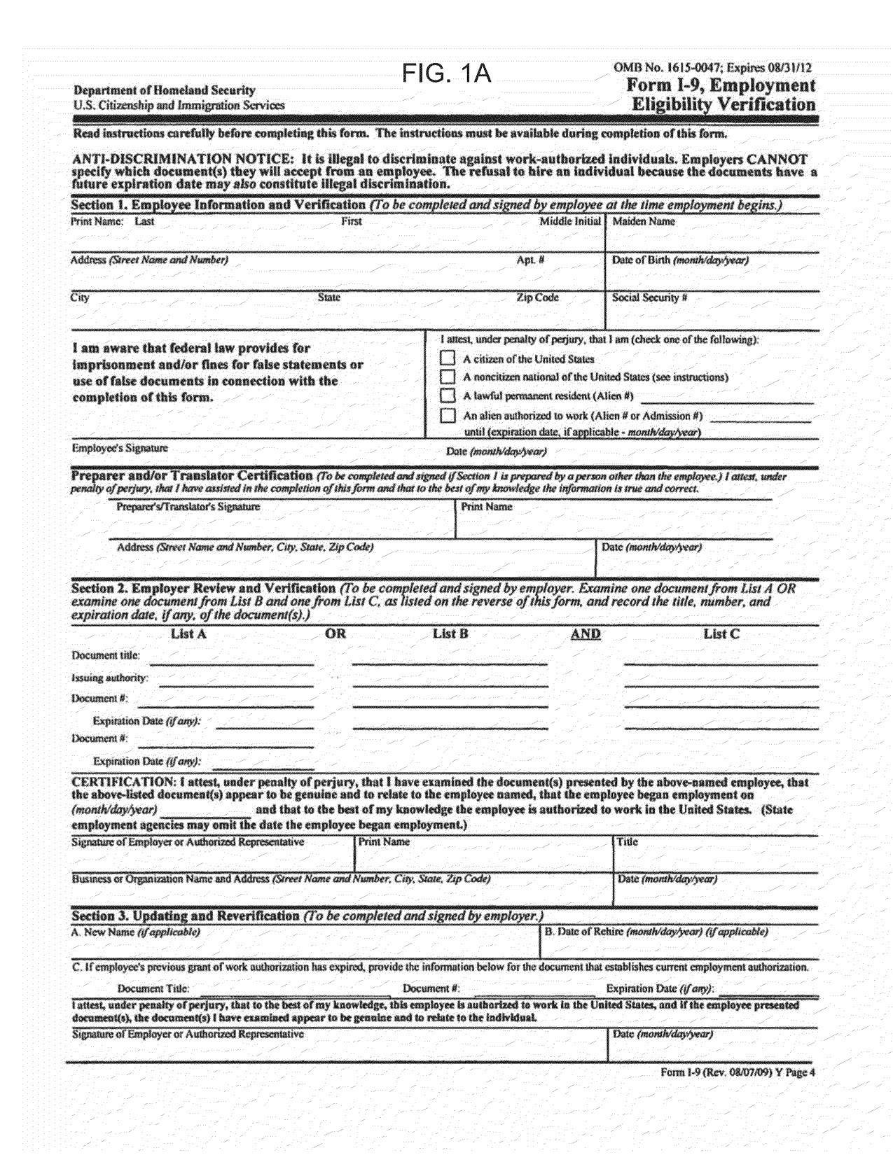

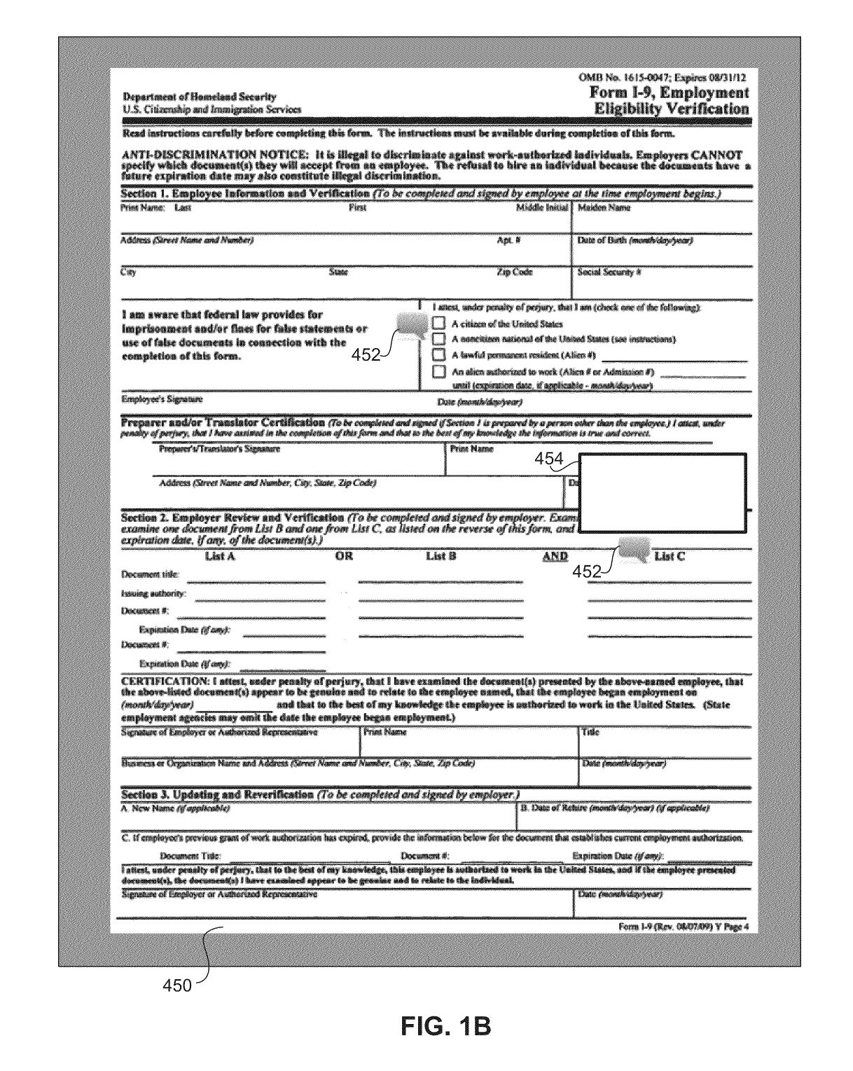

Embodiments of the present disclosure are directed to automated or semi-automated (e.g., computerized and/or computer based) systems and techniques for processing and analyzing worker information or documentation in view of particular regulatory compliance requirements, including immigration compliance requirements; generating compliance violation liability estimates corresponding to such worker information; selectively generating statistical information corresponding to compliance violations and/or compliance violation liability estimates; and managing compliance violation mitigation and/or remediation. In accordance with various embodiments of the present disclosure, workers include or can be construed as employees, and worker information includes employee information or data corresponding to, provided by, or required in association with a standard Form I-9, as depicted in FIG. 1A; and worker information can include one or more types of hard-copy and/or electronic documentation, data, or signals.

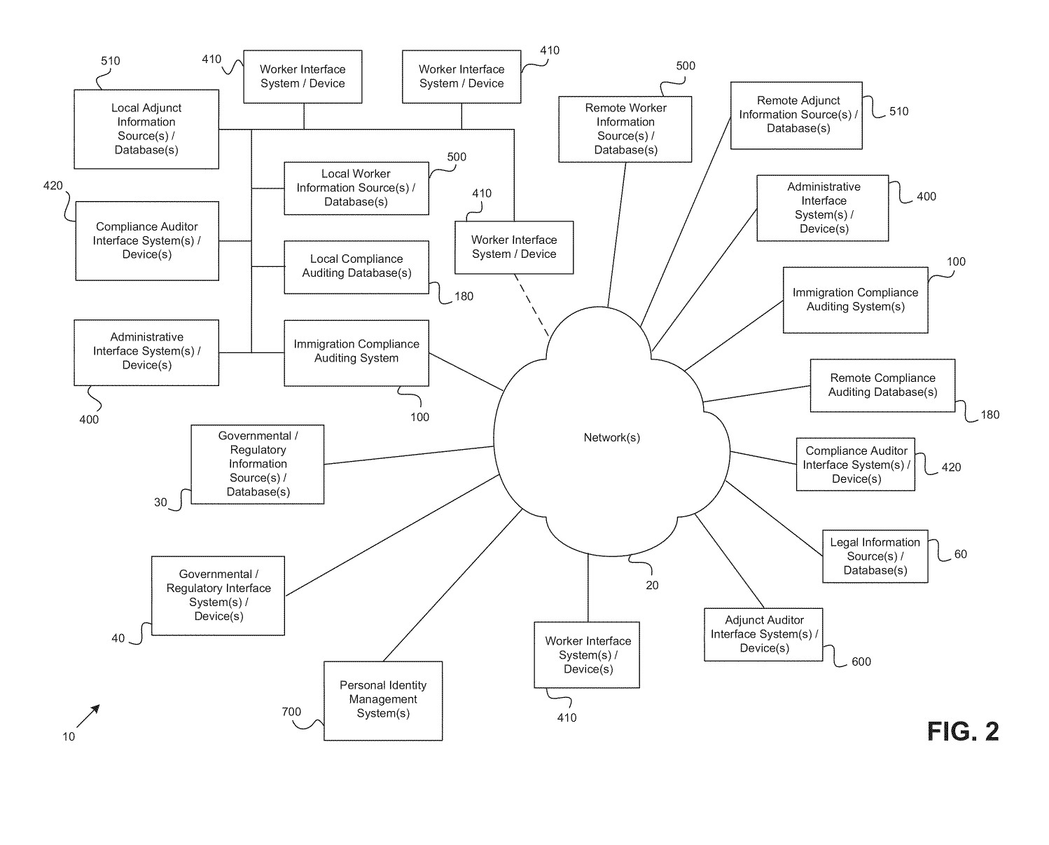

FIG. 2 is a schematic illustration of an architecture 10 for immigration compliance auditing in accordance with an embodiment of the present disclosure. In an embodiment, the architecture 10 includes at least one immigration compliance auditing system 100, which is coupled to a set of local and/or remote compliance auditing databases 180; a set of administrative interface systems/devices 400; a set of worker interface systems/devices 410; a set of compliance auditor interface systems/devices 410; and one or more local and/or remote worker information sources/databases 500. The immigration compliance auditing system(s) 100 can further be coupled to a set of local and/or remote adjunct information sources/databases 510; one or more adjunct auditor interface systems/devices 600; one or more governmental/regulatory information sources/databases 30; a set of governmental/regulatory interface systems/devices 40; and/or a personal identity management system 700. Particular systems, subsystems, devices, and/or information sources/databases can be configured for wire-based and/or wireless communication with a set of networks 20, which can include one or more of a Local Area Network (LAN); a Wide Area Network (WAN); the Internet; a telephone network (e.g., a landline or mobile telephone network); and another type of network (e.g., a satellite network). Manners in which systems, subsystems, devices, and/or information sources/databases are coupled or configured for signal or data communication can depend upon embodiment details.

Portions of an architecture 10 in accordance with an embodiment of the disclosure can be configured or reconfigured in various manners, such as in accordance with embodiment details; technological constraints or advances; and/or the type(s) of employers, organizations, corporations, auditing entities, and/or governmental regulations under consideration. Additionally, portions of one or more systems, subsystems, apparatuses, devices, or elements within the architecture 10 can be distributed across, combined with, or consolidated within one or more portions of other systems, subsystems, apparatuses, devices, or elements of or associated with the architecture 10. For instance, an architecture 10 in accordance with an embodiment of the disclosure can be cloud computing based, Internet server/server farm based, LAN based, or based upon a set of stand-alone systems/devices.

For purpose of simplicity and ease of understanding, aspects of various portions of the architecture 10 are described hereafter in the context of embodiments directed to the analysis of employee information corresponding to Form I-9s, and the generation of corresponding Form I-9 compliance liability auditing estimates. It is to be understood that embodiments in accordance with the present disclosure are not limited to Form I-9 analysis or Form I-9 compliance liability estimate generation. Hence, in the description that follows, reference to the term “Form I-9” is equivalently, correspondingly, or analogously intended to encompass reference to one or more of the terms “worker information,” “worker documentation,” and “worker data.”

In an embodiment, an immigration compliance auditing system 100 includes at least one system and/or set of devices configured accessing, receiving, and/or retrieving one or more lists or records (e.g., database records) of employee names, employee Form I-9 information or data, and possibly supporting data or documentation corresponding to Form I-9 Lists A, B, and C from one or more of administrative interface systems/devices 400; compliance auditor interface systems/interfaces 410; worker information sources/databases 500; adjunct information sources/databases 510; and worker interface systems/devices 420. The system 100 is configured for analyzing Form I-9 data and possibly supporting data; identifying Form I-9 compliance errors or violations; generating and storing Form I-9 compliance violation data or records to facilitate or enable the generation, presentation, and/or tracking of an employer Form I-9 audit trail or history and the establishment, maintenance, preservation, or verification of audit integrity; and generating Form I-9 compliance violation liability auditing estimates. The system 100 is additionally configured for selectively analyzing (e.g., statistically analyzing in accordance with user selectable/user definable/programmably specified parameters) Form I-9 compliance violation data and compliance violation liability auditing estimates. The system 100 is further configured for storing, communicating, and/or presenting Form I-9 compliance violation data/information, remediation and mitigation data, compliance violation liability auditing estimates, and associated analysis of auditing results. Finally, system 100 can be configured to facilitate or manage Form I-9 compliance violation mitigation and/or remediation procedures, which can involve the presentation or provision of mitigation or remediation instructions, guidelines, procedures, recommendations, plans, action items, checklists, graphical user interfaces (GUI), and/or other information.

In general, an immigration compliance auditing system 100 includes a computer system or computing device (e.g., one or more of a desktop computer, a laptop computer, a tablet computer, and a set of servers) having data or signal processing resources (e.g., microprocessor(s)); electronically readable media such as fixed and/or removable data storage or memory resources (e.g., Random Access Memory (RAM), Read Only Memory (ROM), and disk drive resources); communication resources (e.g., data or signal communication interfaces, such as a network interface unit and a set of Universal Serial Bus (USB) interfaces); and possibly presentation or display resources (e.g., a display device such as a flat panel display, computer monitor, or other type of display device). The system 100 includes a memory in which program instructions configured for performing particular Form I-9 compliance auditing operations/processes in accordance with embodiments of the present disclosure reside.

A worker information source/database 500 can include one or more types of sources, systems, or devices from which worker information, documentation, and/or data can be accessed, received, retrieved, or to which such information, documentation, or data can be transferred or stored. An adjunct information source/database 510 can include particular types of sources, systems, or devices from which worker-related and/or other information, documentation, and/or data which is relevant or related to Form I-9 compliance violation auditing analysis and compliance violation liability audit estimation can be accessed, retrieved, or received, or to which such information, documentation, or data can be transferred or stored. Worker and adjunct information sources/databases 500, 510 can include employee records such as employment start and termination dates, payroll history, and electronic Form I-9s and data corresponding thereto/referenced thereby. Adjunct information sources/databases 510 can include databases or electronic repositories to which Form I-9 compliance liability estimates can be communicated, such as organizational or corporate accounting databases, or external accounting firm databases. Worker information sources/databases 500 and adjunct information sources/databases 510 can include various types of electronic systems or devices (e.g., computer systems, computing devices, and electronic devices), including data storage systems/devices and computer readable media. In certain embodiments, a worker information source 500 or an adjunct information source 510 can additionally or alternatively include a source or repository at which hard-copy documentation resides (e.g., a file cabinet).

A governmental/regulatory information source/database 30 can include information pertaining to statutes, regulations, and implementing rules associated with Form I-9 verification compliance, as well as information corresponding to Form I-9 compliance violation penalties such as enforcement policies/procedures; penalty levels; and/or records of assessed penalties. In some embodiments, a governmental information source/database 30 can include governmental or governmentally accepted data or records corresponding to particular individuals such as employees and potential employees, including data indicating whether an individual is authorized or pre-authorized to work in the United States. In certain embodiments, such individuals can interact or exchange information with a governmental information source/database 30 in one or more manners, for instance, by way of a home computer system, an employer's computer system, a distributed network of computing/electronic systems or devices (e.g., a network of employment authorization kiosks), or another type of computer system, computing device or electronic device (e.g., a mobile telephone or smartphone) configured or configurable for communication with a governmental information source/database 30. In general, governmental/regulatory information sources/databases 30 can include one or more types of computing systems or computing devices (e.g., a set of servers).

A compliance auditing database 180 includes particular information or data that an immigration compliance auditing system 100 accesses, generates, or stores in association with identifying and tracking (e.g., on a historical basis) Form I-9 compliance violations, generating/providing Form I-9 compliance liability auditing estimates, performing analyses (e.g., statistical analyses) associated with Form I-9 compliance violations and/or Form I-9 compliance liability estimates, and communicating or presenting Form I-9 compliance liability audit analysis results. A compliance auditing database 180 can selectively include data correlated with, corresponding to, or obtained or communicated from one or more worker information sources/databases 400, adjunct information sources/databases 410, and governmental/regulatory information sources/databases.

Each of an administrative interface system/device 400 and a worker interface system/device 410 can include one or more computing or electronic devices configured to facilitate or effectuate the generation, receipt, retrieval, and/or storage of data corresponding to Form I-9s and supporting documentation. Such systems/devices 400, 410 can include one or more types of computing systems or electronic devices (e.g., a desktop, laptop, or tablet computer, a document scanner or copier, a digital camera, a mobile telephone, or a biometric signal capture device such as a fingerprint capture device, a facial image capture or recognition device, an iris imaging or recognition device, or a voice signal capture or recognition device).

In certain embodiments, an administrative interface system/device 400 or a related system/device (e.g., a worker system/device 410 or an auditor system/device 420) can be configured to present or display an electronic version of a standard Form I-9, and receive user input defining Form I-9 data for a given employee. FIG. 1B is a schematic illustration of a tablet computing computer (e.g., an Apple iPad or similar device) presenting an electronic Form I-9 450 and providing a Form I-9 information entry interface in accordance with an embodiment of the present disclosure. A housing of the tablet computer is identified in FIG. 1B by a darkened border surrounding the electronic Form I-9 450. The electronic Form I-9 450 includes information fields corresponding to the standard Form I-9, and provides graphical objects or elements such as text boxes and check boxes by way of which an employee's Form I-9 data can be entered. The tablet computer also includes a touch, pressure, or proximity sensitive interface, and the electronic Form I-9 450 includes a set of signature input fields configured for receiving signature information corresponding to employee and an employer representative signatures.

In certain embodiments, a GUI associated with a tablet or other computing device configured for presenting an electronic Form I-9 450 can generate one or more types of selectively presentable or selectable graphical widgets such as pop-up icons, balloons, and/or notifications 452 that facilitate the provision of augmentative, explanatory, or instructional information corresponding to Form I-9 information. Such augmentative information can aid a user such as an employer representative (e.g., administrative personnel in an employer's human resources department, or an employee) in understanding aspects Form I-9 requirements. In particular embodiments, in response to user selection of a given pop-up icon 452 (e.g., by way of double clicking a mouse button), the tablet computer can retrieve and present additional corresponding augmentative information to the user, or enlarge or increase an amount of augmentative information presented, for instance, by way of a graphical window 454. Such augmentative information can be retrieved from one or more local or remote information sources or databases.

In some embodiments, an administrative interface system/device 400 includes an optical character recognition (OCR) system. Embodiments having an OCR system include one or more types of OCR software configured for acquiring or extracting marks (e.g., checkmarks) and typewritten, printed, or handwritten characters corresponding to one or more languages from Form I-9s, and converting such marks and characters into electronic signals, data, or codes, such as standardized character codes (e.g., corresponding to ASCII character codes), in a manner understood by one of ordinary skill in the relevant art. An administrative interface system/device 400 or a worker interface system/device 410 can be configured for communication with worker information sources/databases 500, adjunct information sources/databases 510, compliance auditing databases 180, and/or each other.

A compliance auditor interface system/device 420 can include a set of computing and/or electronic systems or devices configured to facilitate or effectuate Form I-9 compliance auditor interaction (e.g., immigration attorney interaction) with one or more Form I-9 compliance auditing systems 100. An adjunct auditor interface system/device 600 can include one or more computing and/or electronic systems or devices configured to receive and possibly process information related to Form I-9 compliance violation liability estimates. In a representative embodiment, an adjunct auditor interface system/device 600 can correspond to an accounting firm, financial institution, potential investor or business partner, or other type of entity that is external to an organization or corporation for whose employees a Form I-9 compliance auditing system 100 generates Form I-9 compliance violation liability estimates. For instance, a set of adjunct auditor interface systems/devices 600 corresponding to an accounting firm or other type of entity may request, retrieve, or receive and evaluate Form I-9 compliance violation analysis results, Form I-9 compliance liability estimates, Form I-9 audit history data, and/or other information associated with an employer as part of merger/acquisition, restructuring, or other due diligence activities.

A governmental/regulatory interface system/device 40 can include one or more computing or electronic devices configured to facilitate or effectuate communication between governmental or regulatory agencies and one or more of Form I-9 compliance auditing systems 100; compliance auditing databases 180; administrative interface systems/devices 400; compliance auditor interface systems/devices 420; adjunct auditor interface systems/devices 600; and personal identity management systems 700. A personal identity management system 700 can include one or more facilities, computing systems, or computing or electronic devices configured for secure management, archival, and selective distribution or provision of employee and/or potential employee data, which can include documentation associated with Form I-9s. In some embodiments, a personal identity system 700 can be associated with or be configured for communication with a governmental information source 30 or records system, such as e-Verify.

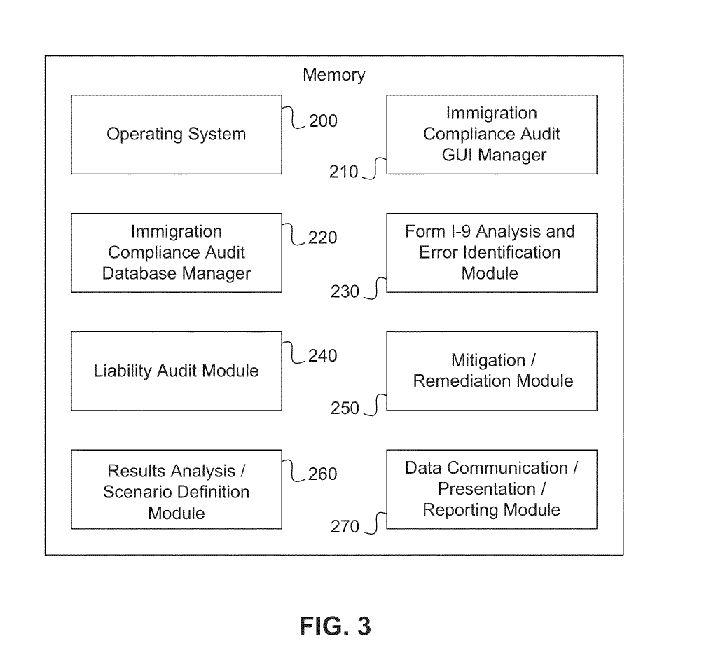

FIG. 3 is a block diagram of particular memory and/or data storage device resident software modules corresponding to a Form I-9 compliance auditing system 100 in accordance with an embodiment of the present disclosure. In an embodiment, a Form I-9 compliance auditing system 100 includes an operating system 200; an immigration compliance audit GUI manager 210 configured for managing or generating a set of GUIs that enable user (e.g., compliance auditor and administrator) interaction with the Form I-9 compliance auditing system 100; an immigration compliance audit database manager 220 configured for managing/updating one or more compliance auditing databases 180; a Form I-9 analysis and error/violation identification module 230 configured for analyzing Form I-9 data and associated information and identifying and storing (e.g., in a database) Form I-9 compliance errors or violations; a liability audit module 240 configured for categorizing Form I-9 compliance violations, storing (e.g., in a database) Form I-9 compliance violation data/histories, and determining compliance violation liability estimates; a mitigation/remediation module 250 configured for determining compliance violation liability mitigation/remediation recommendations, action items, checklists, or procedures; a results analysis/scenario definition module 260 configured for analyzing Form I-9 compliance violation and compliance violation liability estimate results in accordance with user input; and a data communication/presentation/reporting module 270 configured for communicating, presenting, or providing results or reports corresponding thereto. Each of the foregoing software modules includes one or more program instruction sets executable by a processing unit for facilitating, managing, or performing operations, processes, or procedures associated with Form I-9 compliance audit liability estimation in accordance with particular embodiments of the present disclosure.

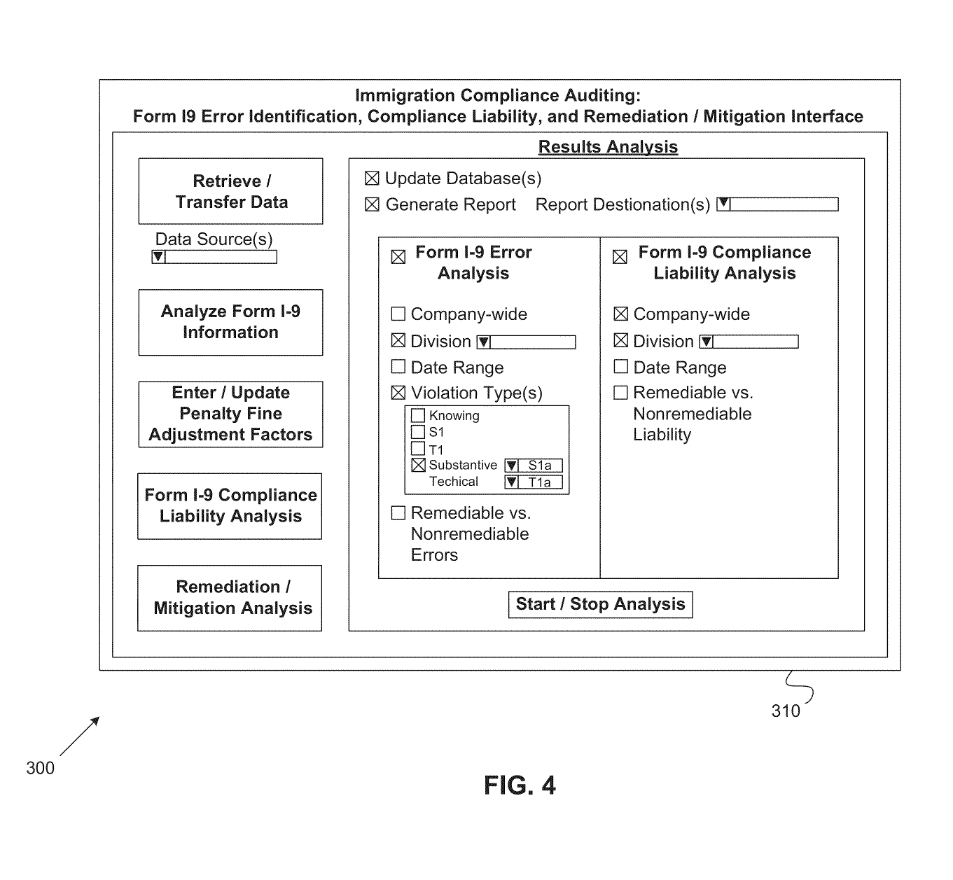

FIG. 4 is a schematic illustration of a representative Form I-9 compliance audit graphical user interface (GUI) 300 in accordance with an embodiment of the present disclosure. In an embodiment, the GUI 300 includes particular types of visual or graphical elements that can be generated and presented in a graphical window 310, such as buttons, check boxes, list boxes, text boxes, and/or other graphical widgets or icons that can be selected or activated in response to user input, such as user input received by way of user interaction with a pointing device or other type of input device. In response to user selection of one or more graphical elements, particular Form I-9 information retrieval, processing, analysis, and/or reporting operations are initiated or performed to facilitate or effectuate immigration compliance auditing processes in accordance with embodiments of the present disclosure.

In association with an immigration compliance liability audit estimation process in accordance with an embodiment of the present disclosure, an immigration compliance auditing system 100 evaluates or analyzes employee lists or records, Form I-9s/Form I-9 data, and possibly associated documentation/data; identifies Form I-9 errors or compliance violations relative to the various types of possible Form I-9 compliance violations that can exist (e.g., including, but not limited to missing Form I-9s, data errors or omissions, and associated documentation/data deficiencies); and maps each occurrence of a Form I-9 compliance violation to a particular categorical type of substantive violation or a particular categorical type of technical or procedural violation. As further detailed hereafter, in various embodiments, distinct categorical types of substantive violations and distinct categorical types of technical/procedural violations are associated with or assigned/linked to distinct symbolic identifiers. Particular symbolic identifiers can correspond to or serve as inputs to a set of mathematical relationships by which Form I-9 compliance violation liability estimates can be generated. Furthermore, such symbolic identifiers, associated descriptive text, current or total cumulative counts of categorical types of substantive and technical/procedural compliance violations corresponding to symbolic identifiers, and possibly statistical information correlated therewith can be presented to an auditor or administrative personnel by way of a display device.

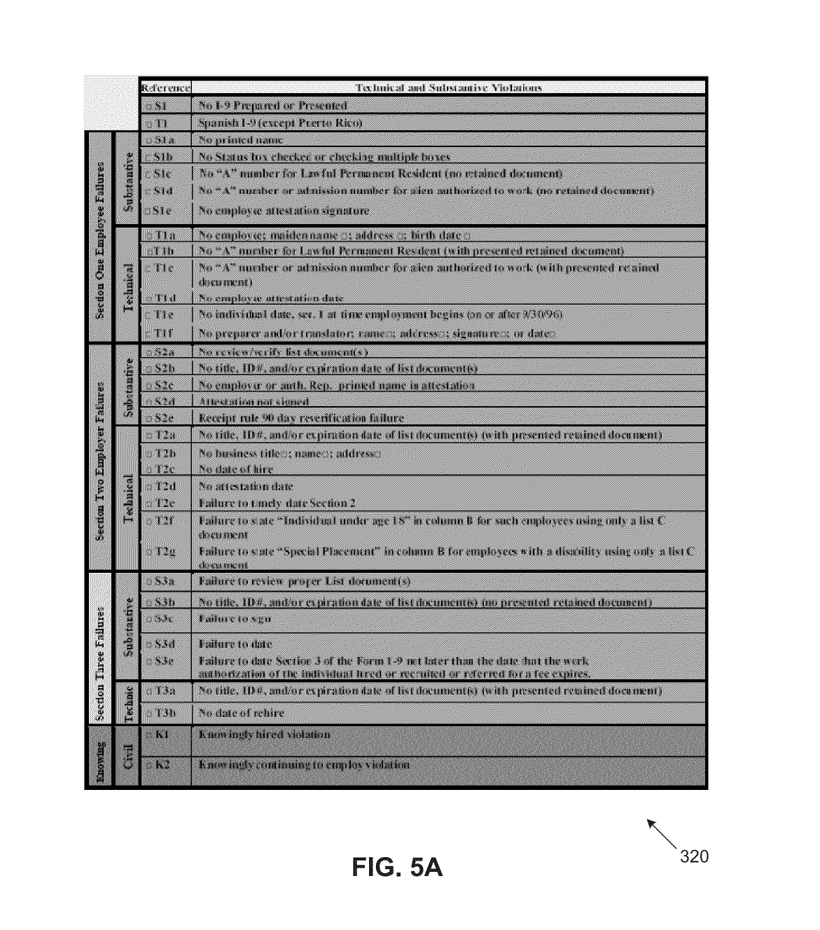

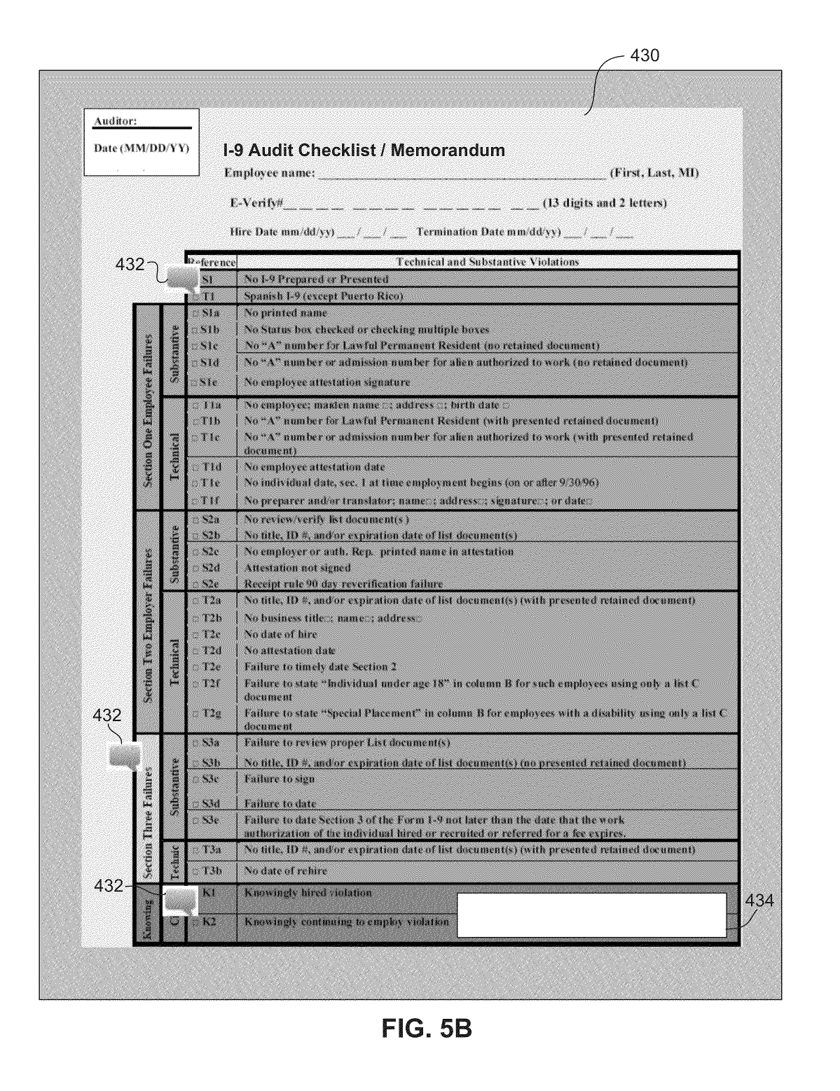

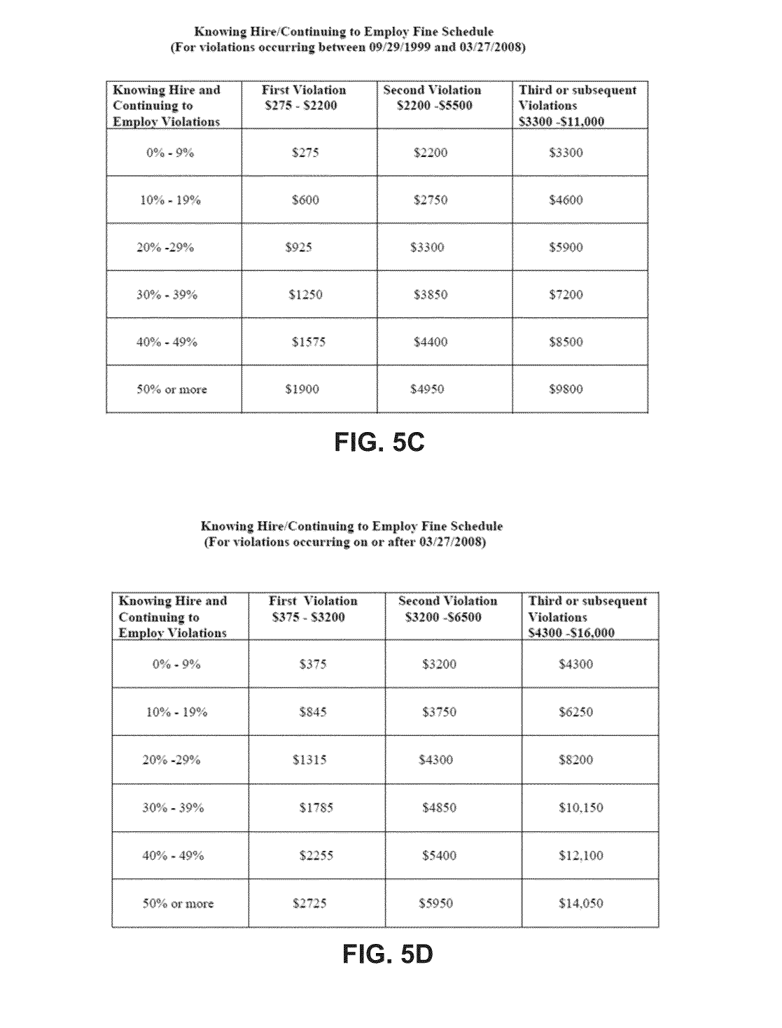

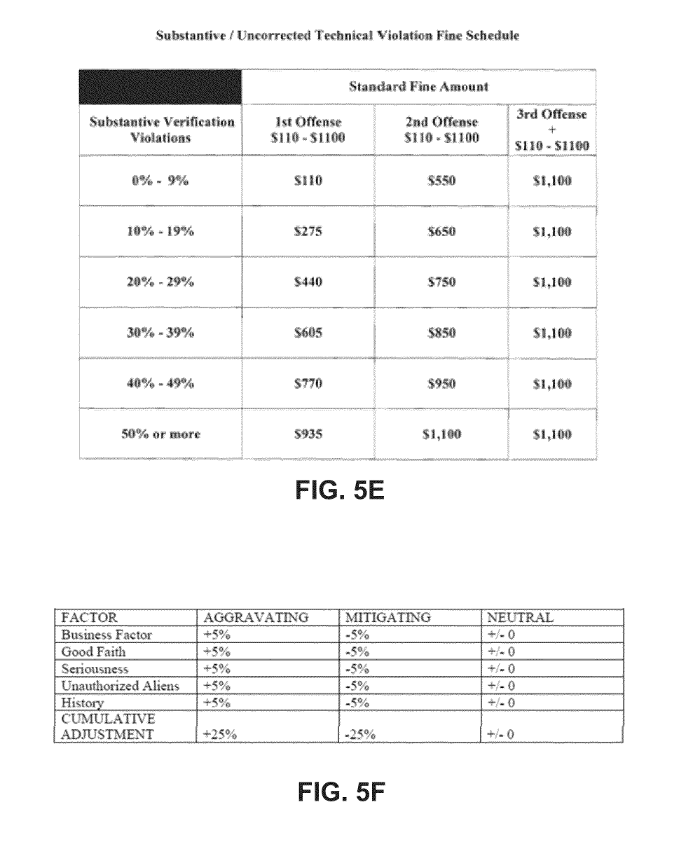

FIG. 5A is a representative Form I-9 compliance violation mapping 320 in accordance with an embodiment of the present disclosure. In an embodiment, such a mapping 320 defines a relationship between each possible type of Form I-9 compliance violation and a categorical type of substantive compliance violation or a categorical type of technical/procedural compliance violation. Each categorical type of substantive compliance violation and each categorical type of technical/procedural compliance violation can be assigned a symbol; in other words, a symbolic representation can be defined for each categorical type of substantive compliance violation and each categorical type of technical/procedural compliance violation. Furthermore, descriptive information or text, and possibly a set of links (e.g., hyperlinks) to explanatory material or other information (e.g., governmental statutes or regulations) can be associated with each such symbol. During a Form I-9 analysis process, counts, tallies, and/or statistical information can be generated to provide or arrive at numerical values for some or all of such symbols, and the numerical values for particular symbols can be used to generate a Form I-9 compliance violation liability estimate. A mapping 320 such as that shown in FIG. 5A, or an electronic definition thereof, can be electronically represented or stored in a data structure or database, such as a compliance auditing database 180. Additional explanatory details corresponding to the mapping 320 shown in FIG. 5A are provided in Immigration Compliance Auditing for Lawyers, Charles A. Miller, Marcine A. Seid, and S. Christopher Stowe, Jr., American Bar Association, ISBN-10: 1616321032, ISBN-13: 978-1616321031, which is incorporated here by reference in its entirety.

In a number of embodiments, an immigration compliance auditing system 100 can automatically analyze employee lists/records, employee Form I-9 data (e.g., corresponding to Form I-9s which were electronically completed and submitted, or which were generated in association with an OCR process performed upon hardcopy Form I-9s), and associated documentation/data to (a) automatically identify and store Form I-9 compliance violations (e.g., missing Form I-9s and Form I-9 errors or omissions), and (b) generate and store Form I-9 compliance violation mapping data corresponding to a set of employees under consideration for a given employer, thereby determining for each of such employees the categorical types of Form I-9 substantive violations and/or categorical types of Form I-9 technical/procedural violations in accordance with the Form I-9 compliance violation mapping 320 of FIG. 5A.

In some embodiments, a Form I-9 compliance violation mapping 320 can facilitate compliance auditor determination, identification, or selection of categorical types of statutory/substantive and technical/procedural Form I-9 compliance violations during a compliance auditor's review of individual employees' Form I-9s; and the definition, receipt, or storage of data corresponding to or identifying such categorical types of statutory and technical compliance violations. More particularly, a visual version of the Form I-9 compliance violation mapping 320 having auditor-selectable fields corresponding to particular statutory and technical compliance violation types, and descriptive information associating each given type of statutory and technical compliance violation with a Form I-9 absence, data error or omission, or associated documentation/data deficiency can be presented to an auditor by way of a display device. A visual version of the Form I-9 compliance violation mapping 320 can also include or provide symbolic representations of categorical types of substantive violations and/or categorical types of technical/procedural compliance violations.

For instance, FIG. 5B is a schematic illustration of a Form I-9 Audit Checklist/Memorandum 330, which can be presented by a display device of a tablet computing device (e.g., an Apple iPad or similar device), the housing of which is identified in FIG. 5B by an outermost darkened border. During auditor review of an employee list, employee Form I-9s, and associated documentation/data, for each missing Form I-9 and Form I-9 error or omission the auditor identifies, the auditor selects or checks a particular box to select or identify an appropriate type of statutory or technical compliance violation type to which the Form I-9 violation corresponds. In response, the auditor's tablet computer can generate or update a data field or data value corresponding to or representing the occurrence of this type of statutory or technical compliance violation. In particular embodiments, an immigration compliance auditing system 100 and an associated tablet or other computing device can (a) generate a preliminary completed Form I-9 Audit Checklist/Memorandum 330 based upon automatically generated Form I-9 compliance violation mapping data; and (b) communicate or present the preliminary completed Form I-9 Audit Checklist/Memorandum 330 to the auditor for review, confirmation, or final approval/acceptance. A set of data values, data fields, and/or data structures corresponding to an auditor's review or analysis of Form I-9s, Form I-9 Audit Checklists/Memoranda 330, and/or the categorical types of statutory and technical violations identified in association therewith can be communicated to an immigration compliance auditing system 100 or a compliance auditing database 180 to facilitate immigration compliance audit Form I-9 liability estimation processes in accordance with an embodiment of the present disclosure.

In certain embodiments, a GUI associated with a tablet or other computing device configured for presenting Form I-9 Audit Checklists/Memoranda 330 can generate one or more types of selectable graphical widgets such as pop-up icons, balloons, and/or notifications 332 that facilitate the provision of augmentative, explanatory, or legal (e.g., case law citation, or compliance violation mitigation/remediation guidance) information corresponding to substantive compliance violation types or a technical/procedural compliance violation types shown in a Form I-9 Audit Checklist/Memorandum 330. Such augmentative information can aid a user such as a compliance auditor or other individual in understanding aspects of a given Form I-9 Audit Checklist/Memorandum 330. In particular embodiments, in response to user selection of a given pop-up icon 332 (e.g., by way of double clicking a mouse button), the tablet computer can retrieve and present additional corresponding augmentative information to the user, or enlarge or increase an amount of augmentative information presented, for instance, by way of a graphical window 334. Such augmentative information can be retrieved from one or more sources, such as specific portions of the text of Immigration Compliance Auditing for Lawyers, which is incorporated here by reference in its entirety as indicated above.

In addition or as an alternative to the foregoing, in certain embodiments, a hard-copy version of the Form I-9 Audit Checklist/Memorandum can be generated for compliance auditor use. After auditor identification of substantive and technical or procedural compliance violation types corresponding to a set of Form I-9s, such hard-copy Form I-9 Audit Checklists/Memoranda can be input to an OCR system, which can identify or extract the statutory and technical compliance violation types identified on each form, and analogously generate, update, and communicate data values, data fields, or data structures to a Form I-9 compliance auditing system 100 or compliance auditing database 180. In some embodiments, information from hard-copy Form I-9 Audit Checklists/Memoranda can be transferred to an immigration compliance auditing system 100 or compliance auditing database 180 by way of manual data entry. Depending upon embodiment details, architectures 10 or systems 100 in accordance with the present disclosure can be configured for automatic, semi-automatic, and/or manual analysis of Form I-9s/Form I-9 data, identification and storage of Form I-9 compliance violations (e.g., errors and/or omissions), and determination of categorical types of substantive or technical or procedural compliance violations associated therewith.

During a compliance liability audit estimation process in accordance with an embodiment of the present disclosure, an immigration compliance auditing system 100 additionally generates one or more liability auditing penalty estimates based upon the types violations identified in association with an analysis of employee Form I-9s, as further detailed below. In association with such a liability estimation process, the system 100 can access or rely upon particular data structures, data fields, or data values corresponding to paperwork or knowing or continuing to employ violations penalty fine schedules, and penalty adjustment factors. FIGS. 5C-5E depict paperwork or knowing or continuing to employ violation penalty fine schedules, which can be stored in a data structure or database; and FIG. 5F depicts penalty adjustment factors, which can be stored in a data structure or database.

One of ordinary skill in the relevant art will understand that one or more aspects of one or more penalty fine schedules and/or penalty adjustment factors can change over time. For instance, statutory monetary penalty fines will increase in the future per the Federal Circuit Penalties Inflation Adjustment Act of 1990, Pub. L. No. 101-410, 29 USC Section 2461. Penalty fine schedules can also change due to policy modification, the introduction of new regulations, or future legal case law interpretation. One or more penalty adjustment factors (currently set forth as +5%, −5%, or 0%) can also change, and the magnitude of penalty adjustment factors need not be applied, apportioned, or divided equally (e.g., by 5%) among the categorical types of such factors, although the current ICE 2009 Policy Memorandum instructs auditors to do so. Various embodiments in accordance with the present disclosure can automatically or semi-automatically retrieve or update penalty fine schedules and/or penalty adjustment factors in accordance with automatically mandated increases or changes in policy, regulations, or case law interpretations, for instance, by retrieving such schedules and/or adjustment factors from one or more governmental/regulatory information sources/databases 30. Such auto-retrieval can occur in response to receipt of a message, notification, or alert from a governmental/regulatory interface system/device 40, or in response to compliance auditor input/instruction/request.

In order to generate one or more liability auditing violation estimates, various embodiments in accordance with the present disclosure generate or maintain cumulative counts of the occurrences of particular types of paperwork or knowing or continuing to employ violation types; map certain of such counts to specific mathematical formulas (e.g., as variable values input to such formulas) to generate penalty reference values; and further map such penalty reference values to compliance violation penalty fines in accordance with the appropriate schedules, such as those corresponding to FIGS. 5C-5E.

Several embodiments in accordance with the present disclosure generate (a) a baseline minimum knowing hire and continuing to employ violation penalty fine, defined herein as B1; (b) a baseline minimum paperwork violation penalty fine, defined herein as B2; and (c) a total baseline penalty fine B_{Tot}, which is the sum of the penalty fines defined by (a) and (b), or B1+B2.

Generation of B1

Such embodiments further access, maintain, determine, or generate the following information:
M1 Master (total count) number of employees for whom Form I-9s should exist
S1 total number of S1 violations “No I-9 Prepared or Presented” (missing I-9s)
K1 Knowingly hired violation count
K2 Knowingly continuing to employ violation count
S3 Count of I-9 Section 3 reverification substantive violations
Knowing Violation Percentage=(K1+K2+S3)/(M1+S1)
Compliance Violation Dates
Violation history data indicating whether the organization or corporation is a first, second, or third/subsequent time violator

Such embodiments subsequently determine a set of minimum base knowing hire/continue to employ fine components by referencing (a) the appropriate compliance violation penalty fine schedule of FIG. 5C or FIG. 5D in accordance with compliance violation date, and (b) further referencing the organization/corporation violation history data to identify or retrieve a corresponding first violation, second violation, or third/subsequent violation penalty fine value. B1, the baseline minimum knowing to hire and continuing to employ violation, is then generated as the sum of each minimum base fine in the set of minimum base knowing hire/continue to employ fine components.

Generation of B2

The embodiments under consideration additionally access, maintain, determine, or generate the following information:
C1=Total number of S1 violations “No I-9 Prepared or Presented” (missing I-9s)
C2=Total number of I-9s with only section 1 substantive or uncorrected technical violations
C3=Total number of I-9s with only section 2 substantive or uncorrected technical violations
C4=Total number of I-9s with both section 1 and section 2 substantive or uncorrected technical violations
Paperwork Violation Percentage=(C1+C2+C3+C4)/(M1+S1)

Such embodiments subsequently determine B2, the minimum baseline paperwork violation fine, by referencing the violation penalty fine schedule of FIG. 5E, in accordance with whether the organization or corporation under consideration is a first, second, or third/subsequent paperwork offense violator. These embodiments can additionally reference the compliance violation date in order to determine the correct baseline paperwork violation fine. More particularly, if a paperwork violation occurred prior to 29 Sep. 1999, the employer is subject to a penalty fine of not less than $100.00 and not more than $1000.00 for each individual for whom a violation occurred. The employer is subject to a penalty fine of not less than $110.00 and not more than $1100.00 for each such individual if the paperwork violation occurred on or after 29 Sep. 1999.

Embodiments in accordance with the present disclosure additionally recognize that uncorrected substantive paperwork violations are considered continuing violations; thus, even for an old substantive paperwork error, if uncorrected, embodiments in accordance with the present disclosure reference an appropriate higher/later penalty fine rate if the employee remains on the organizational or corporate payroll.

The total baseline penalty fine, B_{Tot}, is generated as B1+B2.

Embodiments in accordance with the present disclosure further apply penalty enhancement or reduction factors to the total baseline penalty fine to generate a current liability audit estimate of the range of potential penalties, where such penalty enhancement or reduction factors are defined in accordance with the compliance violation penalty adjustment factors shown in FIG. 5F. Particular penalty adjustment factors can be selected, stored, or updated, such as in response to compliance auditor input, at one or more times, for instance, in view of Immigration and Customs Enforcement (ICE) policy and statutory criteria as interpreted by Office of the Chief Administrative Hearing Officer (OCAHO) Administrative Law Judge (ALJ) decisions.

Depending upon embodiment details, any of the foregoing base, baseline, and current liability auditing penalty estimate values can be stored, communicated to other systems or devices, for instance, corresponding to an employer's internal legal department, outside legal counsel, an internal finance/accounting department, or an external accounting or securities analysis firm, and/or utilized in subsequent analysis procedures. As a representative example, one or more Form I-9 compliance liability estimate values and possibly information associated therewith can be communicated to a finance or accounting database, and information or data corresponding to an appropriate portion of a quarterly or annual financial report or financial statement (e.g., a Form 10-Q) can be automatically updated based upon the Form I-9 compliance liability estimate value(s) to define or identify a current immigration compliance liability (e.g., as an estimated dollar amount) for an organization or corporation.

In view of the foregoing, various embodiments in accordance with the present disclosure can access, utilize, define, retrieve, or store a different or updated/revised Form I-9 compliance violation mapping 320, and accordingly access, provide, or present a visual representation thereof (e.g., a corresponding Form I-9 Audit Checklist/Memorandum 330). Additionally or alternatively, such embodiments can access, utilize, define, retrieve, or store a different or updated/revised set of mathematical relationships by which a Form I-9 compliance liability estimate can be generated. Such different or updated/revised mappings 320, visual mapping representations 330, and/or mathematical relationships can be based upon changes, updates, or revisions to governmental statutes or regulations, or the legal or enforcement/procedural related interpretation/application thereof.

In addition to or in association with the foregoing, embodiments in accordance with the present disclosure automatically determine whether any employee identified in an employee database or list should be considered or exempted for purposes of an immigration compliance liability audit estimation process based upon the statute of limitations for Form I-9 retention. As will be understood by one of ordinary skill in the relevant art, an employer is required to retain each employee Form I-9 for at least three years from the employee's date of hire, or one year from their date of termination, whichever is later.

As indicated above, a system 100 in accordance with an embodiment of the present disclosure can generate, maintain, or update one or more compliance auditing databases 180. In various embodiments, a compliance auditing database 180 includes one or more data structures, data fields, and/or data values identifying each employee under consideration (e.g., every employee named in an employee list or database), and for each such employee, each categorical type of Form I-9 statutory and technical compliance violation that was determined or identified. In particular embodiments in accordance with the present disclosure (e.g., embodiments in which Form I-9s are automatically analyzed in view of Form I-9 absence, data field errors or omissions, and associated documentation/data deficiencies), a compliance auditing database 180 further includes data structures, data fields, or data values identifying each Form I-9 violation that was detected, identified, or determined. A compliance auditing database 180 additionally stores historical, recent, and current base, baseline, and liability audit estimate values.

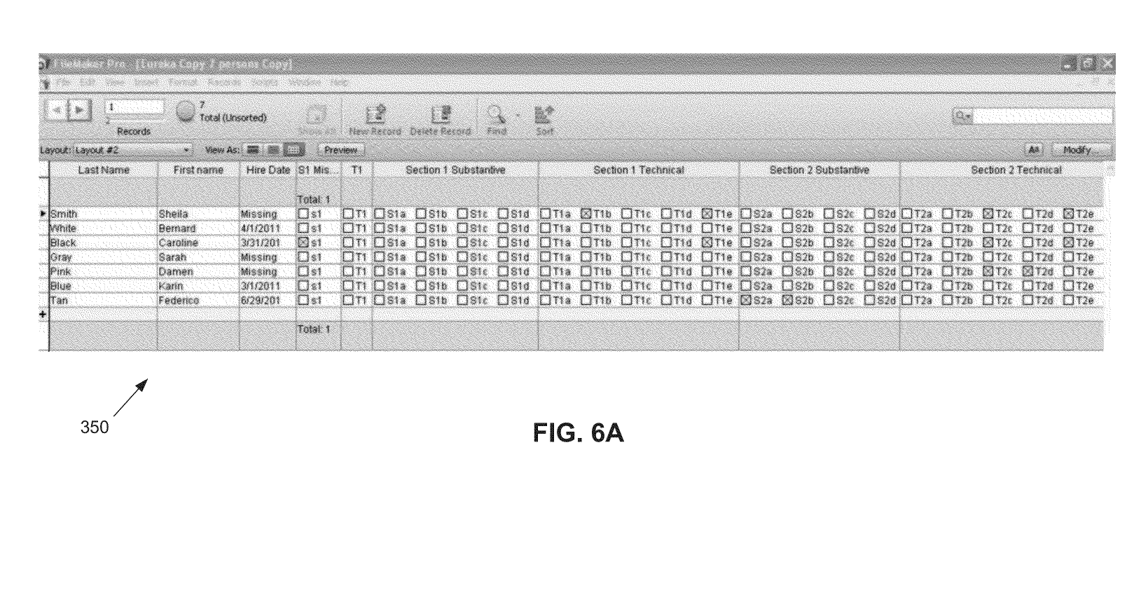

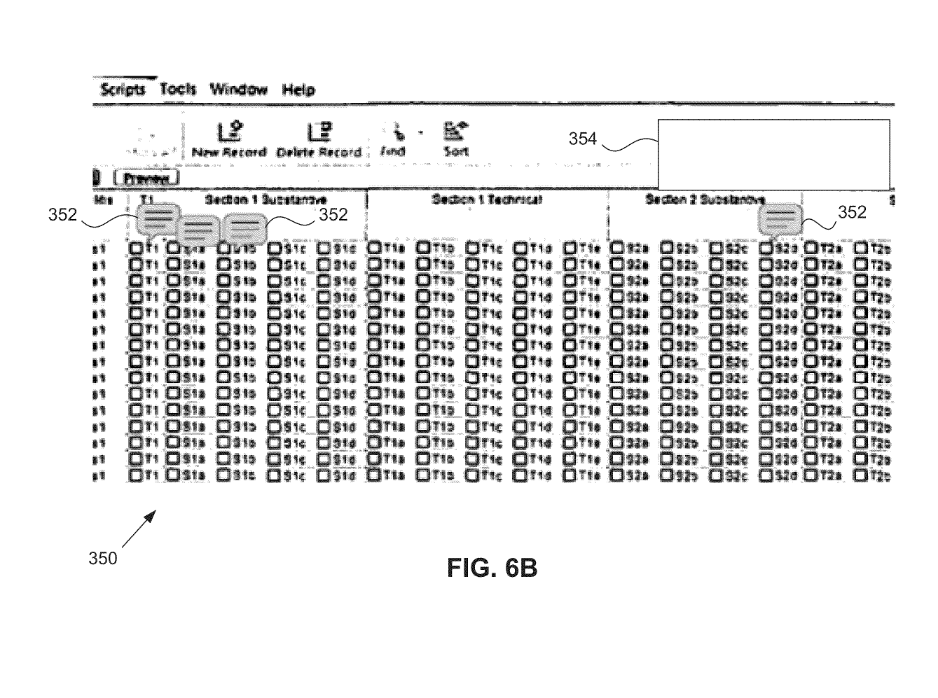

FIG. 6A illustrates a representative immigration compliance auditing database interface 350 in accordance with an embodiment of the present disclosure. In an embodiment, the database interface 350 provides a visual representation of compliance auditing database information corresponding to a set of employees under consideration, where the visual representation includes employee identifiers (e.g., employee name) for such employees, and an indication of the types of paperwork violations corresponding to each of such employees. In several embodiments, the database interface 350 is presented in a spreadsheet format. While the representative interface 350 of FIG. 6A illustrates information corresponding to a small number of employees for purpose of simplicity and to aid understanding, in general systems and processes in accordance with embodiments of the present disclosure can seamlessly (a) manage Form I-9 and associated documentation data for hundreds or thousands of employees, including employees distributed across different corporate departments and/or geographical regions; (b) perform liability auditing estimation processes on such Form I-9 data; (c) statistically analyze such Form I-9 data and compliance liability estimations in a variety of manners; and (d) present associated data and results in a variety of manners.

FIG. 6B illustrates further aspects of the Form I-9 compliance database interface 350 of FIG. 6A. In multiple embodiments, such a database interface 350 generates particular types of selectable graphical widgets such as pop-up icons, balloons, and/or notifications 352 that facilitate the provision of augmentative, explanatory, or legal (e.g., case law citation, or compliance violation mitigation/remediation guidance) information corresponding to statutory and/or technical compliance violation types, which can aid a system user such as a compliance auditor or corporate compliance director or manager. For instance, a pop-up icon 352 can be generated in response to user positioning of a pointing device cursor upon or proximate to a given statutory or technical compliance violation type indicator, such as “T1,” “S1a,” S1b,” or one or more other of such indicators. In particular embodiments, in response to user selection of a given pop-up icon 352 (e.g., by way of double clicking a mouse button), the system 100 can retrieve and present additional augmentative information to the user, or enlarge or increase an amount of augmentative information presented, for instance, by way of a graphical window 354. Such augmentative information can be retrieved from one or more sources, such as specific portions of the text of Immigration Compliance Auditing for Lawyers, which is incorporated here by reference in its entirety as indicated above.

A system 100 in accordance with embodiments of the present disclosure can additionally analyze one or more of Form I-9 compliance violation data, substantive and/or technical or procedural Form I-9 paperwork violation type data, and liability audit estimate data, and generate various types of results, statistics, presentations, reports, and/or summaries corresponding thereto. Such results, presentation, reports, or summaries can be generated or provided in accordance with various types of parameters, such as one or more date ranges, geographic location identifiers, organization or corporate division identifiers, and/or other criteria. Non-limiting representative examples of particular reports that can be provided by embodiments in accordance with the present disclosure are described hereafter.

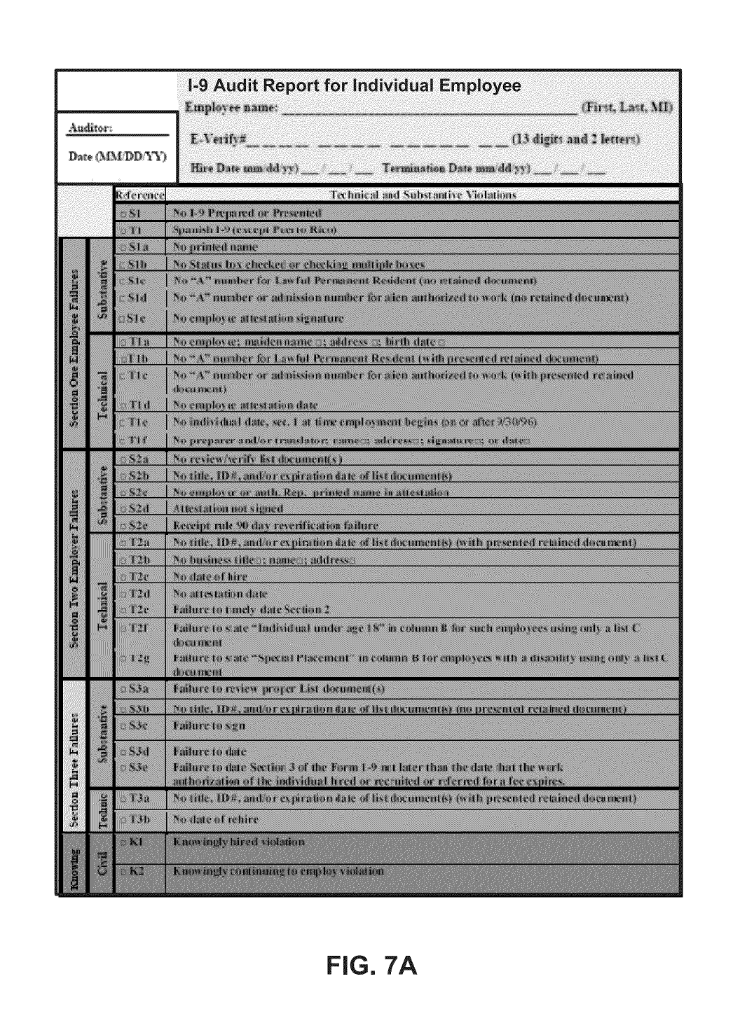

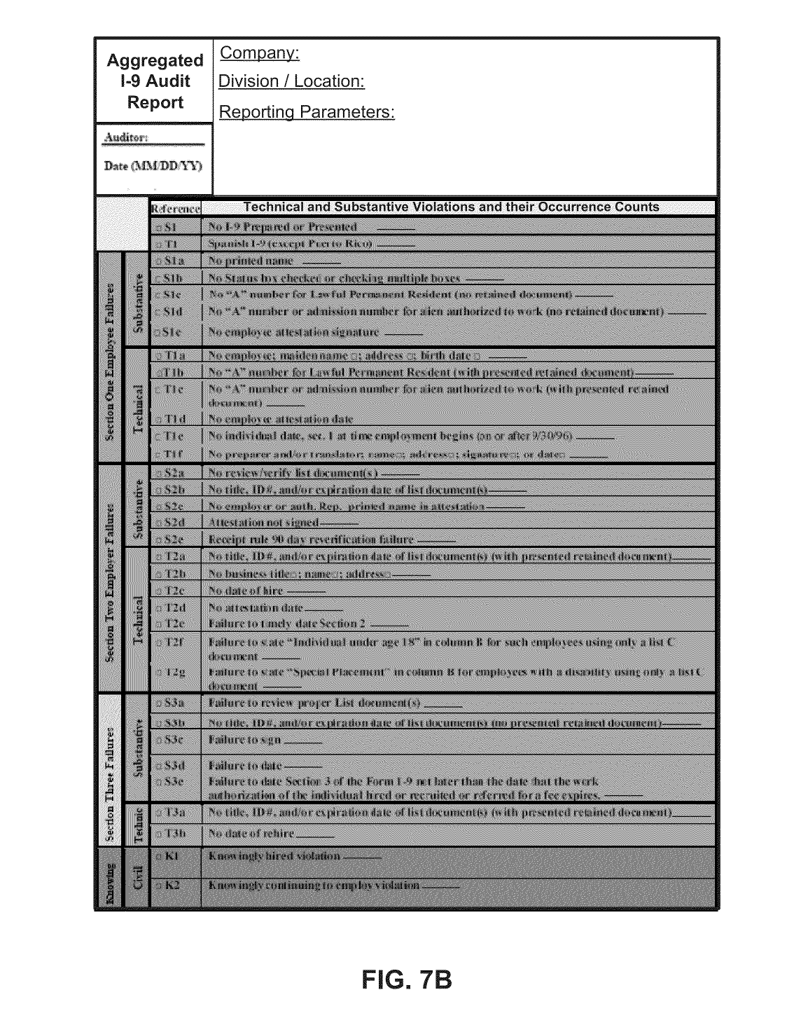

FIG. 7A illustrates a representative Form I-9 Individual Employee Audit Report in accordance with an embodiment of the present disclosure. Such a report can be directly or essentially directly provided based upon a submitted Form I-9 Audit Checklist/Worksheet, or generated using data corresponding to an individual employee within a compliance auditing database 180.

FIG. 7B illustrates a representative Form I-9 Aggregate Compliance Violation Report in accordance with an embodiment of the present disclosure, which can be generated using compliance auditing database data corresponding to multiple employees to present, for instance, an occurrence count corresponding to each type of statutory and technical compliance violation across a pool of employees under consideration (e.g., employees working for a particular corporate division, in a particular geographic region, or at a particular business operation site).

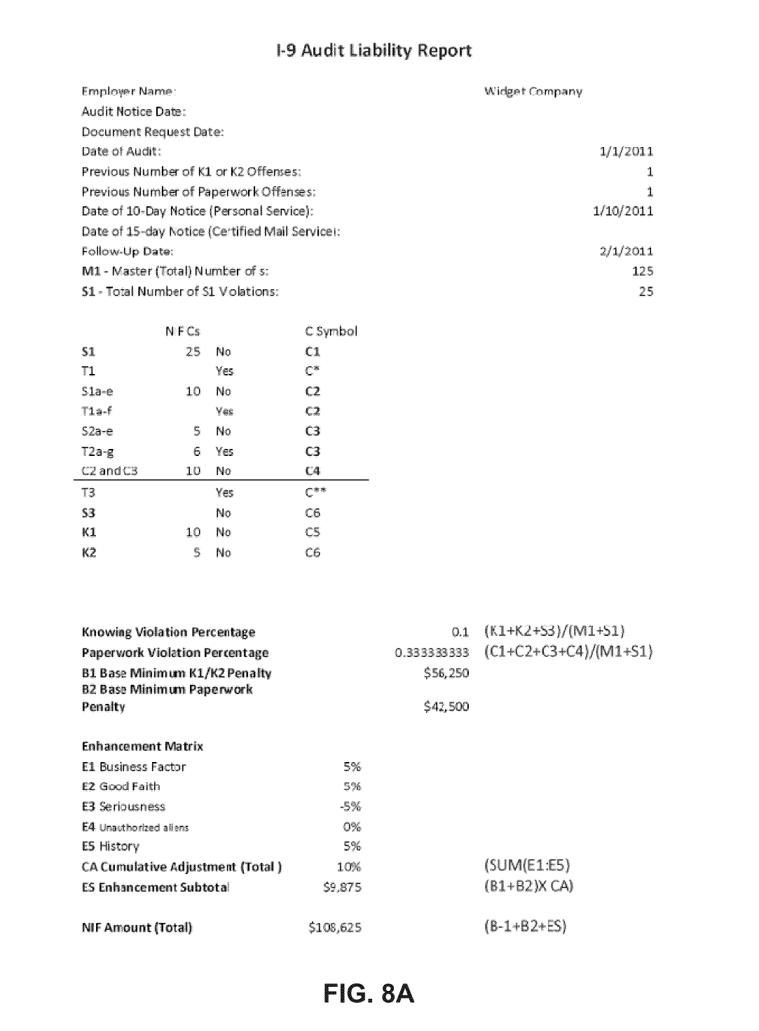

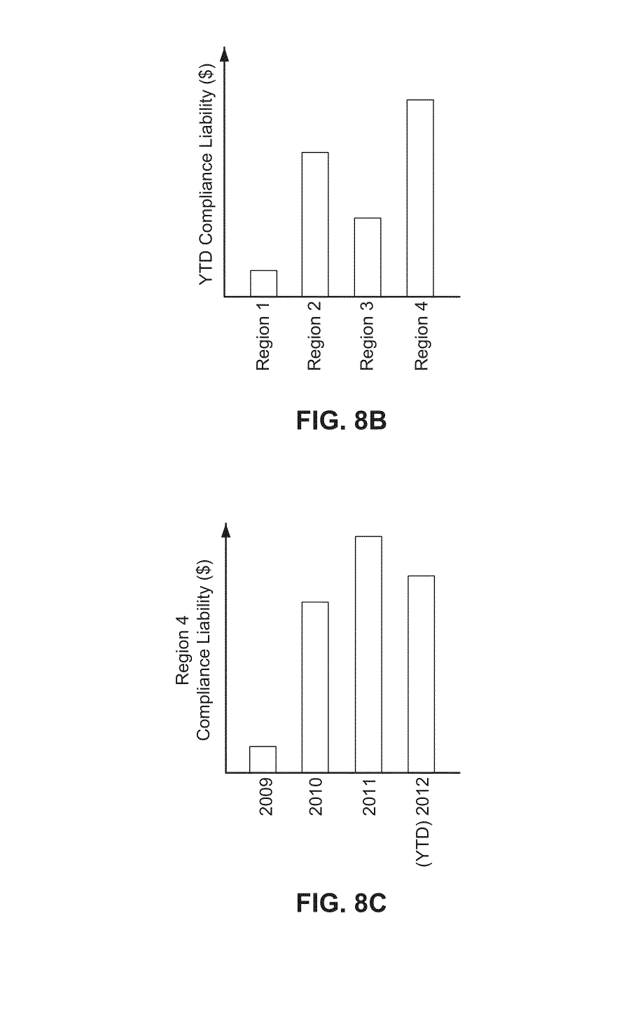

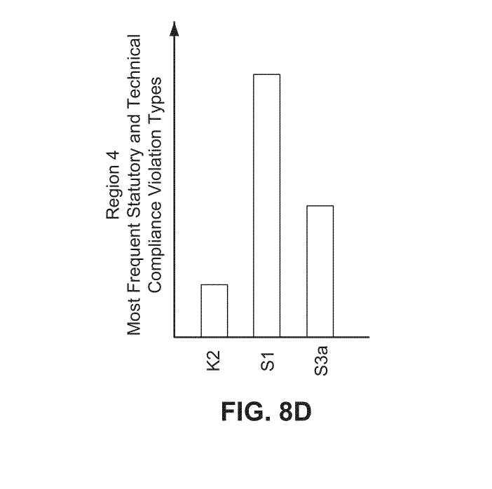

FIG. 8A illustrates a representative Form I-9 Audit Liability Report in accordance with an embodiment of the present disclosure. The Form I-9 Audit Liability Report provides information corresponding to one or more baseline compliance violation penalty amounts (e.g., a base minimum Knowing Hire and Continuing to Employ penalty, as well as a base minimum Paperwork Violation Penalty) and an adjusted violation penalty amount based upon particular exacerbating or mitigating factors. The adjusted compliance violation penalty can be established as a current organizational or corporate compliance violation liability.

FIGS. 8B-8D illustrate particular representative Liability Audit Statistical Reports in accordance with an embodiment of the present disclosure, which are based upon analyses of liability estimates in accordance with particular user specified or user selectable analysis parameters. FIG. 8B illustrates a graph of year-to-date Form I-9 compliance liability estimates across multiple business regions (e.g., geographic regions); FIG. 8C illustrates a graph of historical Form I-9 compliance liability estimates for a particular business region under consideration; and FIG. 8D illustrates a graph of the types of statutory and technical compliance violation types that most frequently occurred (e.g., on a numerical occurrence or relative percentage basis) for a particular business region under consideration.

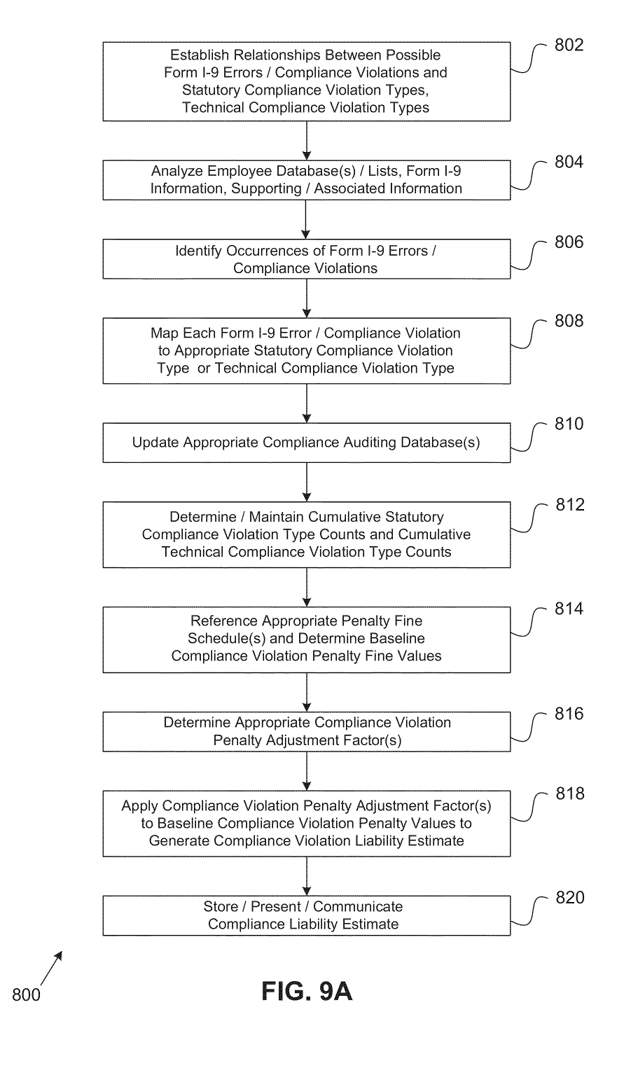

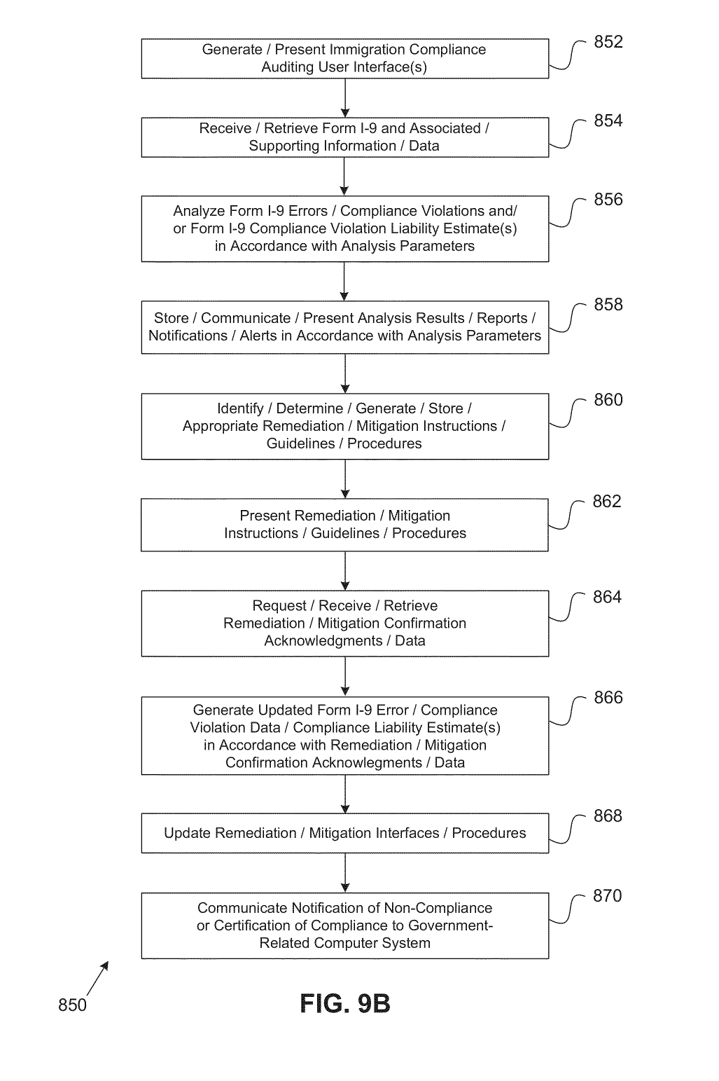

FIG. 9A is a flow diagram 800 of a representative process for performing Form I-9 compliance auditing operations in accordance with an embodiment of the present disclosure. In an embodiment, the process 800 includes a first process portion 802 involving establishing, determining, or defining relationships between possible Form I-9 errors/compliance violations and each of (a) categorical types of statutory/substantive compliance violations and (b) categorical types of technical/procedural compliance violations. The first process potion 802 can involve defining a Form I-9 compliance audit violation mapping 320, as described above.

A second process portion 804 involves analyzing employee data, databases, lists, Form I-9 information, and supporting/associated information, and a third process portion 806 involves identifying or determining occurrences of Form I-9 errors and compliance violations. A fourth process portion 808 involves mapping the identified occurrences of Form I-9 errors and compliance violations to categorical types of statutory and technical compliance violations, and a fifth process portion 810 involves updating one or more compliance databases in accordance with such mapping.

A sixth process portion 812 involves determining/maintaining a cumulative set of statutory compliance violation type counts, and a set of cumulative technical compliance violation type counts. A seventh process portion 814 involves accessing a set of penalty fine schedules, and determining a set of baseline compliance violation penalty fine values. An eighth process portion 816 involves determining a set of compliance violation penalty adjustment factors, and a ninth process portion 818 involves applying the set of compliance violation penalty adjustment factors to the set of baseline compliance violation penalty values to generate a compliance violation liability estimate. Finally, a tenth process portion 820 involves storing, presenting, or communicating a set of compliance liability estimates, message, notifications, or alerts (e.g., sms or mms messages, or e-mail messages) to one or more systems, devices, or parties.

FIG. 9B is a flow diagram of a representative process 850 for managing Form I-9 compliance auditing information, results, and/or remediation activities in accordance with an embodiment of the present disclosure. In an embodiment, the process 850 includes a first process portion 852 involving generating a set of immigration compliance auditing user interfaces, and a second process portion 854 involving receiving or retrieving Form I-9 and associated supporting information. A third process portion 856 involves analyzing Form I-9 errors/compliance violations and/or Form I-9 compliance violation liability estimates in accordance with a set of analysis parameters, and a fourth process portion 858 involves storing, communicating, or presenting analysis results, reports, notifications, and/or alerts (e.g., sms or mms messages, or e-mail messages) in accordance with the analysis parameters.

A fifth process portion 860 involves identifying, determining, or retrieving an appropriate or expected appropriate set of remediation/mitigation instructions, guidelines, or procedures based upon a current set of Form I-9 compliance violations under consideration, and a sixth process portion 862 involves communicating or presenting the set of remediation/mitigation instructions or guidelines, for instance, by way of a display device associated with an immigration compliance auditor or employer administrative personnel. In an embodiment, the system 100 can include a remediation/mitigation mapping that defines relationships between particular Form I-9 compliance violations and remediation/mitigation instructions or guidelines, which can be provided by or retrieved or obtained from one or more sources. For instance, remediation/mitigation instructions or guidelines can be provided by portions of Immigration Compliance Auditing for Lawyers, which is incorporated herein by reference as indicated above. Additionally or alternatively, remediation/mitigation instructions or guidelines can be provided by a governmental/regulatory information source/database 30. In certain embodiments, these instructions or guidelines can be retrieved or received from a governmental/regulatory information source/database 30 following official governmental updates to such instructions or guidelines. A remediation/mitigation mapping that associates particular types of Form I-9 compliance violations with remediation/mitigation instructions or guidelines can be electronically represented or stored in a data structure or database, such as a compliance auditing database 180.

A seventh process portion 864 involves requesting, receiving, or retrieving remediation and/or mitigation acknowledgment confirmations. Such confirmations can indicate that an employer or an individual associated therewith (e.g., an immigration attorney/auditor or employer corporate counsel) confirms the set of remediation/mitigation procedures have been satisfied, and remediation/mitigation activities have been completed such that the current set of Form I-9 compliance violations have been addressed (e.g., completely, or to the extent possible). An eighth process portion 866 involves generating updated Form I-9 error/compliance violation data and corresponding updated compliance liability estimates in accordance with the remediation/mitigation acknowledgment confirmations. An ninth process portion 868 involves updating remediation/mitigation procedures based upon the updated Form I-9 error/compliance violation data and the updated compliance liability estimates.

Finally, a tenth process portion 870 involves communicating a notice of employer Form I-9 non-compliance or a notice/certification of employer Form I-9 compliance to a governmental agency or body, for instance, by way of electronically sending a dated Form I-9 non-compliance notification or a dated Form I-9 compliance certification to a computer system associated by the governmental agency. Receipt of a notice of employer Form I-9 non-compliance can indicate to the governmental agency that as of a given date, the employer has undertaken a Form I-9 liability audit, and is aware of or has initiated remediation/mitigation activities. A certificate of Form I-9 compliance can indicate to the governmental agency or another organization or entity (e.g., an accounting firm, financial institution, or potential investor or business partner) that as of a given date, the employer formally satisfies governmental Form I-9 requirements (e.g., to the fullest extent possible) for the employer's past and present employees. In an embodiment, a certification of employer Form I-9 compliance can be communicated by way of a compliance auditor interface system/device 420, or by way of an administrative interface system/device, provided that the certification bears a digital or physical date, and an appropriate digital or physical date and compliance auditor signature.

Aspects of particular embodiments of the present disclosure address at least one aspect, problem, limitation, and/or disadvantage associated with prior systems and methods for managing and analyzing worker documentation in view of statutory and regulatory requirements. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, components, processes, or alternatives thereof, may be desirably combined into other different systems, components, processes, and/or applications. In addition, various modifications, alterations, and/or improvements may be made to various embodiments described above.

For example, in some embodiments, prior to the analysis of all or all currently available worker information and Form I-9s/Form I-9 data corresponding to an employer, at one or more times during the processing/analysis of worker information and Form I-9s/Form I-9 data to identify Form I-9 compliance violations (e.g., substantive and technical/procedural errors indicated above), or on an ongoing, essentially continuous, concurrent, or “on-the-fly” basis with respect to the processing/analysis of worker information and Form I-9s/Form I-9 data, an immigration compliance auditing system 100 can maintain cumulative counts or tallies of different categorical types of Form I-9 errors (e.g., in accordance with a Form I-9 compliance violation mapping 320), and present such counts and/or statistics corresponding thereto to an auditor or administrative personnel by way of a display device. Additionally or alternatively, the system 100 can generate Form I-9 compliance liability estimates at one or more times or on an ongoing/on-the-fly basis as worker information and Form I-9s/Form I-9 data is processed/analyzed, and present a current or partial Form I-9 compliance liability estimate to the auditor or administrative personnel. For instance, in a situation in which the system 100 is to process and analyze worker information and Form I-9s/Form I-9 data for an employer having a total of 2000 employees, the system 100 can generate and present the aforementioned information to an auditor or administrative personnel for each group of k employees (e.g., k=50, 100, 250, or 500) for whom worker information and Form I-9s/Form I-9 data has been processed and analyzed.

Additionally or alternatively, in certain embodiments each electronically stored Form I-9 data set corresponding to an employee is associated with or linked to (e.g., by way of a database field) an employer division or department identifier, and/or an administrative personnel identifier corresponding to an administrative employee responsible for reviewing the employee's Form I-9 information. During or following the analysis of worker information and Form I-9s/Form I-9 data, an immigration compliance auditing system 100 can maintain cumulative counts or tallies of each Form I-9 compliance violation and/or categorical type of Form I-9 compliance violation on an employer division/department identifier or administrative personnel identifier basis. The system 100 can present such “by division/department” or “by responsible administrative personnel” Form I-9 compliance violation counts or tallies, and/or statistics corresponding thereto, to an auditor or administrative personnel by way of a display device, during (e.g., at particular intervals, such as for every set of k employees considered) or after the processing/analysis of worker information and Form I-9s/Form I-9 data.

With respect to each of the preceding examples, an immigration compliance auditing system 100 can provide a configuration interface responsive to user input for selectively defining information that the system 100 is to maintain and/or present to an auditor or administrative personnel, and under which circumstances such information is to be presented, while processing and analysis of worker information and Form I-9s/Form I-9 data is underway.

The foregoing examples and other variations/modifications fall within the scope of the present disclosure.

1. A computer implemented method for generating a Form I-9 compliance liability estimate for an employer associated with a set of employees, the method comprising:
identifying statutory Form I-9 compliance violations and technical Form I-9 compliance violations corresponding to each employee within the set of employees;
mapping each identified statutory Form I-9 compliance violation to a categorical type of statutory compliance violation;
mapping each identified technical Form I-9 compliance violation to a categorical type of technical compliance violation;
automatically determining a cumulative count of each categorical type of statutory compliance violation;
automatically determining a cumulative count of each categorical type of technical compliance violation; and
automatically determining the Form I-9 compliance liability estimate in a manner correlated with the cumulative count of each categorical type of statutory compliance violation and the cumulative count of each categorical type of technical compliance violation.

2. The method of claim 1, wherein automatically determining the Form I-9 compliance liability estimate comprises:
determining a baseline minimum statutory penalty fine;
determining a baseline minimum technical penalty fine;
determining a baseline minimum Form I-9 compliance liability penalty fine comprising the baseline minimum statutory penalty fine plus the baseline minimum technical penalty fine;
determining a penalty adjustment factor corresponding to the employer;
applying the penalty adjustment factor to the baseline minimum Form I-9 compliance liability penalty fine to arrive at the Form I-9 compliance liability estimate for the employer; and
storing the Form I-9 compliance liability estimate.

3. The method of claim 2, wherein determining the baseline minimum statutory penalty fine comprises determining a percentage of statutory knowing type violations.

4. The method of claim 3, wherein determining the percentage of statutory knowing type violations comprises determining for the set of employees a total number of knowingly hired violations, a total number of knowingly continued to employ violations, and a total number of employer Form I-9 reverification failures.

5. The method of claim 3, wherein determining the percentage of statutory knowing type violations comprises determining for the set of employees (a) a total number of knowingly hired violations, a total number of knowingly continued to employ violations, and a total number of employer Form I-9 reverification failures, relative to (b) a total number of employees for whom Form I-9s should exist, plus a total number of substantive type Form I-9 compliance violations corresponding to employee failures.

6. The method of claim 2, wherein determining the baseline minimum statutory penalty fine further comprises referencing a knowing hire/continuing to employ penalty fine schedule.

7. The method of claim 6, wherein determining the baseline minimum statutory penalty fine further comprises referencing employer violation history data.

8. The method of claim 2, wherein determining the baseline minimum technical penalty fine comprises determining a percentage of technical paperwork type violations.

9. The method of claim 8, wherein determining the percentage of technical paperwork type violations comprises determining a total number of missing Form I-9s, a total number of Form I-9s having a first subset of categorical types of violations, a total number of Form I-9s having a second subset categorical types of violations different than the first subset categorical types of violations, and a total number of Form I-9s having both the first subset and the second subset of categorical types of violations.

10. The method of claim 8, wherein determining the percentage of technical paperwork type violations comprises determining (a) a total number of missing Form I-9s, a total number of Form I-9s having a first subset of categorical types of violations, a total number of Form I-9s having a second subset categorical types of violations different than the first subset categorical types of violations, and a total number of Form I-9s having both the first subset and the second subset of categorical types of violations, relative to (b) the total number of employees for whom Form I-9s should exist, plus the total number of substantive type Form I-9 compliance violations corresponding to employee failures.

11. The method of claim 8, wherein determining the baseline minimum technical penalty fine further comprises referencing a technical violation penalty fine schedule.

12. The method of claim 2, wherein mapping each identified statutory Form I-9 compliance violation to a categorical type of statutory compliance violation and mapping each identified technical Form I-9 compliance violation to a categorical type of technical compliance violation occurs in accordance with an electronically stored Form I-9 compliance violation mapping.

13. The method of claim 12, further comprising presenting a Form I-9 audit checklist/memorandum on a display device, the Form I-9 audit checklist/memorandum comprising a visual representation of the Form I-9 compliance violation mapping.

14. The method of claim 13, wherein presenting the Form I-9 audit checklist/memorandum on the display device comprises presenting a visual representation of the Form I-9 compliance violation mapping in a manner responsive to user input directed to one of inputting categorical types of Form I-9 violations corresponding to an employee into the Form I-9 audit checklist/memorandum and verifying categorical types of Form I-9 violations corresponding to an employee presented by the Form I-9 audit checklist/memorandum.

15. The method of claim 12, further comprising presenting on a display device an individual Form I-9 audit report corresponding to an individual employee, the individual Form I-9 audit report comprising a visual representation of the Form I-9 compliance violation mapping and visual indications categorical types of statutory compliance violations and categorical types of technical compliance violations corresponding to the employee.

16. The method of claim 12, further comprising presenting on a display device an aggregated Form I-9 audit report corresponding to the employer, the aggregated Form I-9 audit report comprising a visual representation of the Form I-9 compliance violation mapping and visual indications of cumulative categorical types of statutory compliance violations and cumulative categorical types of technical compliance violations corresponding to the employer.

17. The method of claim 1, further comprising communicating one of a notification of employer Form I-9 non-compliance and a certification of employer Form I-9 compliance to a computer system corresponding to a government agency.

18. A system for generating a Form I-9 compliance liability estimate for an employer associated with a set of employees, the system comprising an immigration compliance auditing system, the immigration compliance auditing system comprising:
a processing unit configured for executing program instructions; and
a memory coupled to the processing unit, the memory including a Form I-9 liability audit module comprising executable program instructions configured for:
identifying statutory Form I-9 compliance violations and technical Form I-9 compliance violations corresponding to each employee within the set of employees;
mapping each identified statutory Form I-9 compliance violation to a categorical type of statutory compliance violation;
mapping each identified technical Form I-9 compliance violation to a categorical type of technical compliance violation;
determining a cumulative count of each categorical type of statutory compliance violation;
determining a cumulative count of each categorical type of technical compliance violation; and
determining the Form I-9 compliance liability estimate in a manner correlated with the cumulative count of each categorical type of statutory compliance violation and the cumulative count of each categorical type of technical compliance violation.

19. The system of claim 18, wherein the liability audit module comprises executable program instructions configured for determining the Form I-9 compliance liability estimate by way of:
determining a baseline minimum statutory penalty fine;
determining a baseline minimum technical penalty fine;
determining a baseline minimum Form I-9 compliance liability penalty fine comprising the baseline minimum statutory penalty fine plus the baseline minimum technical penalty fine;
determining a penalty adjustment factor corresponding to the employer; and
applying the penalty adjustment factor to the baseline minimum Form I-9 compliance liability penalty fine to arrive at the Form I-9 compliance liability estimate for the employer.

20. The system of claim 19, wherein the liability audit module comprises executable program instructions configured for determining the baseline minimum statutory penalty fine by way of determining a percentage of statutory knowing type violations.

21. The system of claim 20, wherein the liability audit module comprises executable program instructions configured for determining the percentage of statutory knowing type violations by way of determining for the set of employees a total number of knowingly hired violations, a total number of knowingly continued to employ violations, and a total number of employer Form I-9 reverification failures.

22. The system of claim 20, wherein the liability audit module comprises executable program instructions configured for determining the percentage of statutory knowing type violations by way of determining for the set of employees (a) a total number of knowingly hired violations, a total number of knowingly continued to employ violations, and a total number of employer Form I-9 reverification failures, relative to (b) a total number of employees for whom Form I-9s should exist, plus a total number of substantive type Form I-9 compliance violations corresponding to employee failures.

23. The system of claim 19, wherein the wherein the liability audit module comprises executable program instructions configured for determining the baseline minimum statutory penalty fine by way of referencing a knowing hire/continuing to employ penalty fine schedule.

24. The system of claim 23, wherein the liability audit module further comprises executable program instructions configured for determining the baseline minimum statutory penalty fine by way of referencing employer violation history data.

25. The system of claim 19, wherein the liability audit module comprises executable program instructions configured for determining the percentage of technical paperwork type violations by way of determining a total number of missing Form I-9s, a total number of Form I-9s having a first subset of categorical types of violations, a total number of Form I-9s having a second subset categorical types of violations different than the first subset categorical types of violations, and a total number of Form I-9s having both the first subset and the second subset of categorical types of violations.

26. The system of claim 19, wherein the liability audit module comprises executable program instructions configured for determining the percentage of technical paperwork type violations by way of determining (a) a total number of missing Form I-9s, a total number of Form I-9s having a first subset of categorical types of violations, a total number of Form I-9s having a second subset categorical types of violations different than the first subset categorical types of violations, and a total number of Form I-9s having both the first subset and the second subset of categorical types of violations, relative to (b) the total number of employees for whom Form I-9s should exist, plus the total number of substantive type Form I-9 compliance violations corresponding to employee failures.

27. The system of claim 19, wherein the liability audit module comprises program instructions for determining the baseline minimum technical penalty fine by way of referencing a technical violation penalty fine schedule.

28. The system of claim 18, further comprising at least one of a database of employee data corresponding to the set of employees and a Form I-9 database storing Form I-9 data associated with the set of employees.

29. The system of claim 18, wherein the system includes a Form I-9 database storing Form I-9 data associated with the set of employees, and wherein the system further comprises a Form I-9 analysis and error identification module comprising executable program instructions configured for analyzing Form I-9 data within the Form I-9 database and identifying Form I-9 compliance violations.

30. The system of claim 18, wherein the memory further comprises a Form I-9 compliance violation mapping that defines relationships between (a) statutory Form I-9 compliance violations and categorical types of statutory compliance violations, and (b) technical Form I-9 compliance violations and categorical types of technical compliance violations.

31. The system of claim 30, wherein the system further comprises a compliance auditor interface system having a display device configured to present a visual representation of the Form I-9 compliance violation mapping.

32. The system of claim 31, wherein the visual representation of the Form I-9 compliance violation mapping comprises a Form I-9 audit checklist/memorandum, and wherein the compliance auditor interface system is configured to receive user input directed to one of inputting categorical types of Form I-9 violations corresponding to an employee into the Form I-9 audit checklist/memorandum and verifying categorical types of Form I-9 violations corresponding to an employee presented by the Form I-9 audit checklist/memorandum.

33. The system of claim 31, wherein the compliance auditor interface system comprises a tablet computer.

34. The system of claim 30, wherein the system further comprises a reporting module comprising executable program instructions configured for presenting on a display device at least one of (a) an individual Form I-9 audit report corresponding to an individual employee, the individual Form I-9 audit report comprising a visual representation of the Form I-9 compliance violation mapping and visual indications categorical types of statutory compliance violations and categorical types of technical compliance violations corresponding to the employee, and (b) an aggregated Form I-9 audit report corresponding to the employer, the aggregated Form I-9 audit report comprising a visual representation of the Form I-9 compliance violation mapping and visual indications of cumulative categorical types of statutory compliance violations and cumulative categorical types of technical compliance violations corresponding to the employer.

35. The system of claim 18, further comprising a communication module comprising executable program instructions configured for communicating one of a notice of employer Form I-9 non-compliance and a certification of employer Form I-9 compliance to a computer system corresponding to a government agency.
